(19) United States
(12) Patent Application Publication
(10) Pub. No.: US 2015/0378289 A1
(43) Pub. Date: Dec. 31, 2015

(54) IMAGE FORMING APPARATUS AND THE IMAGE FORMING METHOD

(71) Applicant: TOSHIBA TEC KABUSHIKI KAISHA, Tokyo (JP)

(72) Inventors: Satoshi Kinouchi, Tokyo-to (JP); Ryota Saeki, Mishima-shi (JP); Takaho Watanabe, Mishima-shi (JP); Tokihiko Ise, Tagata-gun (JP)

(21) Appl. No.: 14/317,119

(22) Filed: Jun. 27, 2014

(51) Int. Cl. G03G 15/20; G03G 15/01

(52) U.S. Cl. CPC G03G 15/2039

(57) ABSTRACT

In accordance with one embodiment, an image forming apparatus comprising a printer section configured to include a first image forming section which forms a monochrome image with inerasable coloring agent and a plurality of color image forming sections at least one of which forms a color image with erasable coloring agent; and a control section configured to control the printer section so that the printer section operates in a first mode of forming a monochrome image through the first image forming section, a second mode of forming an erasable image with the erasable coloring agent, and a third mode of forming an image through the first image forming section and the plurality of color image forming sections.

### FIELD

Embodiments described herein relate to an image forming apparatus and an image forming method which can form an image with erasable coloring agent and inerasable coloring agent.

### BACKGROUND

Conventionally, as a full color image forming apparatus applied to high-speed printing, there is known a quadruple tandem type full color image forming apparatus provided with four photoconductors and four developing devices which are arranged nearby each photoconductor and in which inerasable cyan (C), magenta (M), yellow (Y) and black (BK) toner is stored, respectively.

There is also an image forming apparatus for forming an image with erasable toner. In a case of adding an image forming section which forms an image with erasable toner to the quadruple tandem type image forming apparatus, it is necessary to arrange a dedicated photoconductor for the erasable toner, which leads to a problem of oversize of the apparatus.

Further, in a case of forming an erasable image, a general inerasable color image or a monochrome image using the quadruple tandem type image forming section, in the quadruple tandem type image forming section, the first station forms an image with erasable toner, and the second, third and fourth stations form color images and monochrome images with inerasable cyan (C), magenta (M) and yellow (Y) toner. However, it is necessary to use three colors (C, M and Y) of color toner to form an inerasable monochrome image, which leads to a problem of high cost.

### BRIEF DESCRIPTION OF THE DRAWINGS

FIG. 1 is a diagram illustrating the constitution of an image forming apparatus according to one embodiment;

FIG. 2 is an external view illustrating an operation panel of the image forming apparatus according to the embodiment;

FIG. 3 is a block diagram illustrating the constitution of a control system of the image forming apparatus according to the embodiment;

FIG. 4A, FIG. 4B and FIG. 4C are illustration diagrams illustrating the constitution and the operations of a moving mechanism according to the embodiment; and

FIG. 5 is an illustration diagram illustrating the relation between each toner and the heating temperature of a fixing device according to the embodiment.

### DETAILED DESCRIPTION

In accordance with one embodiment, an image forming apparatus comprising a printer section configured to include a first image forming section which forms a monochrome image with inerasable coloring agent and a plurality of color image forming sections which form at least one color image with erasable coloring agent within a plurality of color images; a fixing device configured to fix the image formed by the printer section on a recording medium; and a control section configured to control the printer section so that the printer section operates in a first mode of forming a monochrome image through the first image forming section, a second mode of forming an erasable image with the erasable coloring agent, and a third mode of forming an image through the first image forming section and the plurality of color image forming sections.

Hereinafter, the image forming apparatus according to the embodiment is described in detail with reference to the accompanying drawings. In addition, same reference numerals are applied to the same components in each figure.

### A First Embodiment

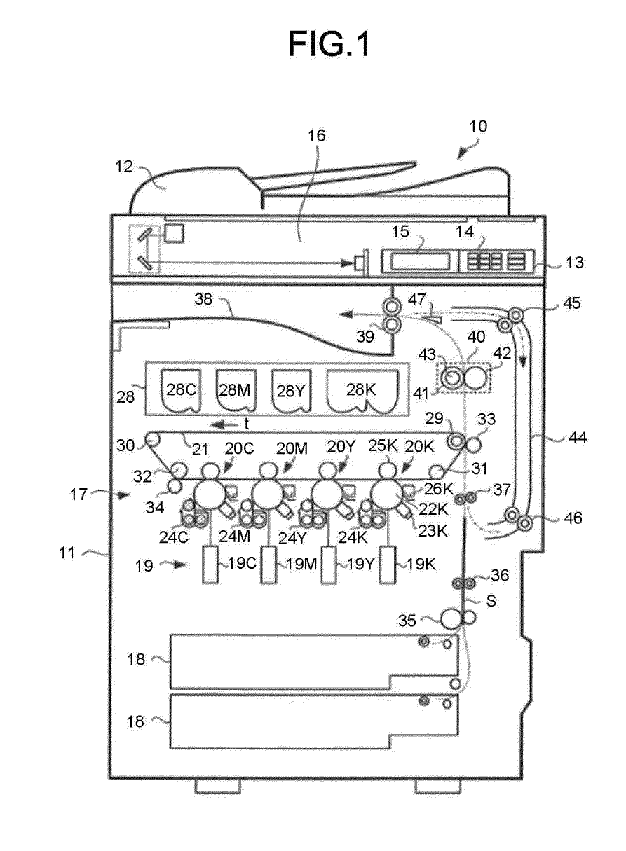

FIG. 1 is a diagram illustrating the constitution of the image forming apparatus according to the embodiment. In FIG. 1, an image forming apparatus 10 is, for example, an electrophotographic type, electrostatic recording type or magnetic recording type multi-function peripheral (MFP). In addition to the MFP, a printer, a copier, a facsimile and the like may also be used as the image forming apparatus 10, however, in the following description, the MFP is described as an example.

At the upper portion of a main body 11 of a MFP 10 is arranged a document table above which an ADF (Automatic Document Feeder) 12 is arranged in an openable and closable manner. Further, an operation panel 13 is arranged at the upper portion of the main body 11. The operation panel 13 includes various operation keys 14 and a touch panel type display section 15.

A scanner section 16, which is arranged under the ADF 12 inside the main body 11, reads the document fed by the ADF 12 or the document placed on the document table to generate image data. A printer section 17 is arranged at the center part of the main body 11, and a plurality of cassettes 18 are arranged at the lower part of the main body 11 to store paper of various sizes. The printer section 17 consisting of a photoconductive drum, a scanning head and the like processes the image data read by the scanner section 16 and the image data created by, for example, a PC (Personal Computer), and fixes an image on paper serving as a recording medium. The paper on which an image is fixed by the printer section 17 is discharged to a paper discharge section 38.

The printer section 17, which is, for example, a tandem-form color laser printer, exposes the photoconductor with the light from a scanning head 19 to generate an image. The printer section 17 includes cyan (C), magenta (M), yellow (Y) and black (K) image forming sections 20C, 20M, 20Y and 20K. The image forming sections 20C, 20M, 20Y and 20K are arranged in parallel under a transfer belt 21, which is capable of moving in a direction indicated by an arrow t, along a direction from the upstream side to the downstream side. The scanning head 19 includes a plurality of scanning heads 19C, 19M, 19Y and 19K corresponding to the image forming sections 20C, 20M, 20Y and 20K. The scanning heads 19C, 19M, 19Y and 19K are respectively provided with LED elements serving as light sources arranged in a line at intervals in a horizontal scanning direction.

In the present embodiment, the image forming section 20K forms an image with inerasable black coloring agent (hereinafter referred to as BK toner as needed). The image forming sections 20C, 20M and 20Y constitute a color image forming section which forms a plurality of color images. In the image forming sections 20C, 20M and 20Y, the image forming section 20C forms an image with erasable cyan coloring agent (hereinafter, referred to as C toner as needed). The image forming sections 20M and 20Y form images with inerasable yellow coloring agent (hereinafter, referred to as Y toner as needed) and magenta coloring agent (hereinafter, referred to as M toner as needed).

As the image forming sections 20C, 20M, 20Y and 20K are structurally identical to each other, the image forming section 20K is described as a representative example. However, the toner stored in a developing device 24C of the image forming section 20C is erasable cyan toner, while the toner stored in developing devices 24M, 24Y and 24K is inerasable toner.

The erasable C toner stored in the developing device 24C can cause, for example, a reversible color generation/erasing reaction which erases the color if the temperature is above a specific temperature and generates color if the temperature is below a given color recovery temperature. As the coloring agent used in the erasable toner, any coloring agent that can be erased by raising the temperature by heating and can recover the color if the temperature is below a specific temperature can be used. For example, the leuco dye is generally used as well-known coloring agent, and the coloring agent is selected which is formed by combining the leuco dye with color developing agent, color erasing agent, color changing temperature adjusting agent and the like properly and can erase the color if the temperature is above a certain temperature and recover the color if the temperature is below a certain temperature.

The image forming section 20K is provided with a photoconductive drum 22K around which an electrostatic charger 23K, a developing device 24K, a transfer roller 25K, a cleaner 26K and the like are arranged. A toner cartridge 28 is arranged above the image forming sections 20C, 20M, 20Y and 20K to supply toner for the developing devices 24C, 24M, 24Y and 24K. The toner cartridge 28 consists of cyan (C), magenta (M), yellow (Y) and black (K) toner cartridges 28C, 28M, 28Y and 28K which are adjacent to each other.

From a viewpoint of heat resistance and abrasion resistance, for example, a semi-conductive polyimide is used as the transfer belt 21 which moves cyclically. The transfer belt 21 is stretched by a drive roller 29 and driven rollers 30, 31 and 32. The transfer belt 21 faces the photoconductive drum 22K and can be contacted with the photoconductive drum 22K. At the position where the transfer belt 21 faces the photoconductive drum 22K, a primary transfer voltage is applied by the transfer roller 25K to primarily transfer a toner image on the photoconductive drum 22K to the transfer belt 21.

Further, a secondary transfer roller 33 is arranged opposite to the drive roller 29. When paper S passes through the space between the drive roller 29 and the secondary transfer roller 33, a secondary transfer voltage is applied by the secondary transfer roller 33 to secondarily transfer the toner image on the transfer belt 21 to the paper S. A belt cleaner 34 is arranged nearby the driven roller 32 of the transfer belt 21.

Light is emitted from the scanning head 19 to the exposure position of the photoconductive drum 22K to form an electrostatic latent image on the surface of the photoconductive drum 22K. The electrostatic charger 23K uniformly charges the entire surface of the photoconductive drum 22K. The developing device 24K supplies two-component developing agent including toner and carrier for the photoconductive drum 22K through a developing roller to form a toner image on the photoconductive drum 22K. After the toner image on the photoconductive drum 22K is primarily transferred to the transfer belt 21, the cleaner 26K removes the toner left on the surface of the photoconductive drum 22K.

Further, a separation roller 35 for taking out the paper S in a paper feed cassette 18, a conveyance roller 36 and a register roller 37 are arranged along the conveyance path from the paper feed cassette 18 to the secondary transfer roller 33, and a fixing device 40 is arranged at the downstream side of the secondary transfer roller 33. The fixing device 40 includes a heat roller 41, a press roller 42, a driving section for rotating the heat roller 41, and a heat source 43 such as a halogen lamp which is arranged inside the heat roller 41.

The paper S to which the toner image is secondarily transferred by the secondary transfer roller 33 is conveyed to the fixing device 40 and heated when passing through the space between the heat roller 41 and the press roller 42, thereby fixing the toner image on the paper S.

In addition, the fixing device 40 functions as a color erasing device which erases the color of the paper S at a temperature higher than the temperature applied to fix the toner image on the paper S. That is, the paper S on which an image is formed with the erasable C toner is conveyed to the fixing device 40, and the image formed with the erasable C toner is erased if the temperature of the fixing device 40 is set to a specific temperature higher than the general fixing temperature.

A paper discharge roller 39 for discharging the paper S to the paper discharge section 38 is arranged at the downstream side of the fixing device 40. The paper S is conveyed through a conveyance path from the conveyance roller 36 via the register roller 37 to the secondary transfer roller 33, and a conveyance path from the secondary transfer roller 33 to the paper discharge roller 39.

The conveyance roller 36, the register roller 37 and the paper discharge roller 39 constitute a paper conveyance section which conveys the paper S to the printer section 17 and conveys the paper on which an image is formed by the printer section 17 to the paper discharge section 38.

Further, a reversal conveyance path 44 which is used when carrying out duplex printing is arranged. The reversal conveyance path 44 is provided with a plurality of conveyance rollers 45 and 46. The paper S is conveyed from the paper discharge roller 39 towards the paper discharge section 38 temporarily, and then switched back and conveyed to the reversal conveyance path 44. On the reversal conveyance path 44, the paper S is guided towards the direction of the secondary transfer roller 33 through the rotation of the conveyance rollers 45 and 46. That is, the paper S passing through the fixing device 40 is guided to the paper discharge section 38 or the reversal conveyance path 44 by a distribution gate 47.

The operations of the image forming apparatus 10 are briefly described. If image information is input from the scanner section 16 or a personal computer terminal (PC) and the like, Images are formed with C toner, M toner, Y toner and BK toner by each of the image forming sections 20C-20K. The magenta (M), cyan (Y) and black (K) toner images are multiple-transferred at the same position where the yellow (C) toner image is formed on the transfer belt 21 to obtain a full color toner image.

The full color toner image on the transfer belt 21 is secondarily transferred to the paper S by the secondary transfer roller 33. The paper S is fed from the paper feed cassette 18 to the position of the secondary transfer roller 33. The paper S to which the toner image is secondarily transferred is conveyed to the fixing device 40 to fix the toner image on the paper S. On the other hand, after the secondary transfer is completed, the toner left on the transfer belt 21 is cleaned by the belt cleaner 34.

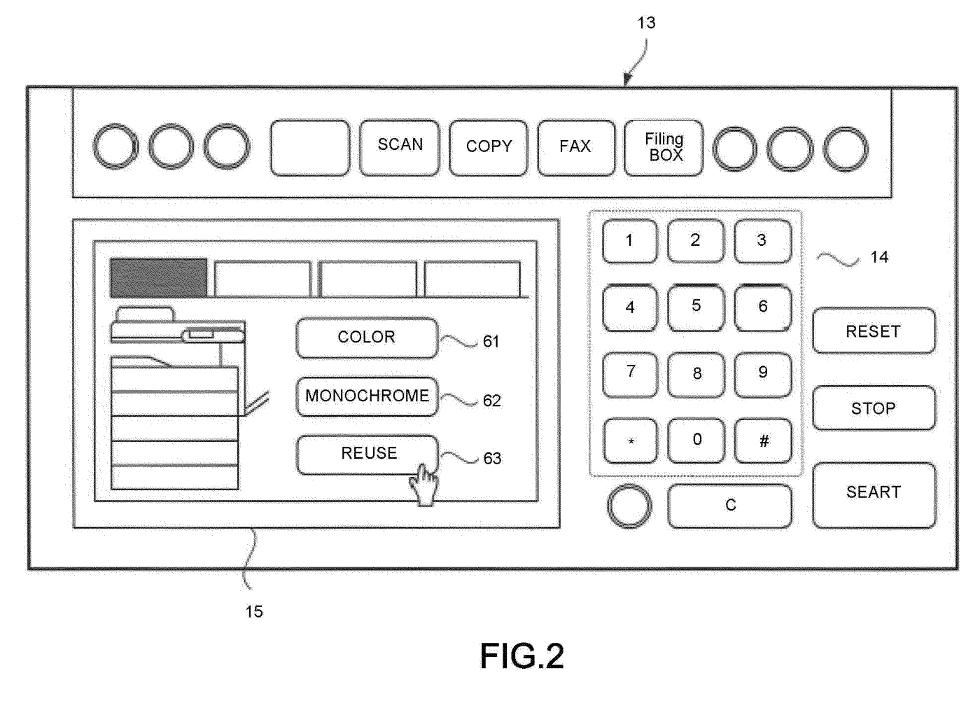

FIG. 2 is an external view illustrating the operation panel 13 serving as an operation section of the MFP 10. The operation panel 13 includes various operation keys 14 and the display section 15 which is, for example, a liquid crystal display section. The operation keys 14 include a numeric key, a start key and the like.

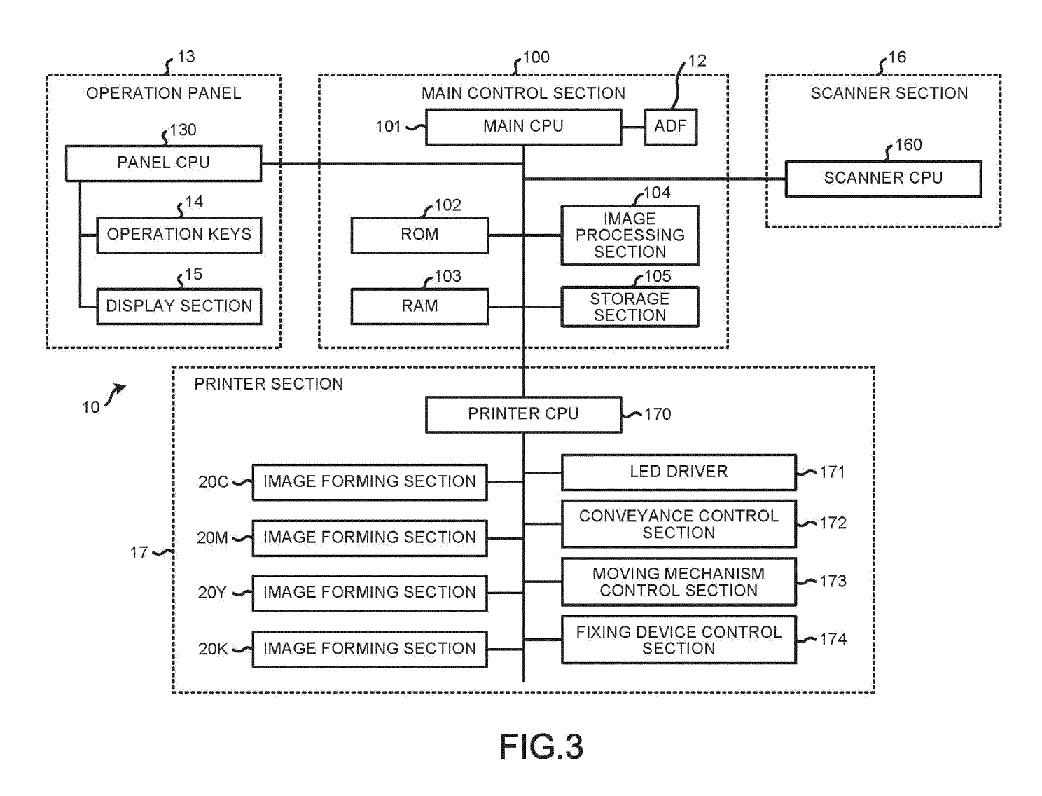

FIG. 3 is a block diagram illustrating the constitution of a control system of the image forming apparatus (MFP) 10 according to the embodiment. In FIG. 3, the MFP 10 comprises a main control section 100, the operation panel 13, the scanner section 16 and the printer section 17. The control system of the MFP 10 carries out communication among a plurality of CPUs including a main CPU 101 in the main control section 100, a panel CPU 130 of the operation panel 13, a scanner CPU 160 of the scanner section 16 and a printer CPU 170 of the printer section 17.

The main control section 100 comprises, the main CPU 101, a ROM 102, a RAM 103, an image processing section 104 and a storage section 105 such as a HDD. The main CPU 101 controls the ADF 12 and the whole operations of the MFP 10. The ROM 102 stores control programs and the like. The RAM 103 stores data temporarily.

The image processing section 104 processes the image data read by the scanner section 16 and the image data from the PC and the like and carries out various image processing, for example, an image conversion processing of enlarging/reducing an image.

The storage section 105 compresses and stores the image data read by the scanner section 16 and the image data (file data, drawing image data and the like) from the PC. The image data stored in the storage section 105 is input to the image processing section 104 and subjected to various image processing, and then printed on paper by the printer section 17.

The operation panel 13 includes the panel CPU 130 connected with the main CPU 101, various operation keys 14 and the display section 15 consisting of a liquid crystal display and the like. The operation keys 14 include a numeric key for instructing the number of printings and the like. The display section 15 has a touch panel function for inputting an instruction of the paper size, printing magnification, simplex printing and duplex printing. Further, a user can touch the display section 15 to designate a printing mode such as monochrome printing (monochrome mode), full color printing (full color mode), printing with erasable ink (reuse mode) and the like.

The scanner section 16 includes a CCD driver for driving an image sensor, and the CCD driver drives the image sensor to read the image on the document and convert the image into image data.

The printer section 17, which comprises the printer CPU 170, a LED driver 171 for driving the LED elements of the scanning head 19, a conveyance control section 172 for controlling the conveyance of the paper S, a moving mechanism control section 173 for controlling a moving mechanism (described later), and a fixing device control section 174 for controlling the fixing device 40, carries out printing on paper through the cooperation with the main control section 100. The fixing device control section 174 controls the rotation of the heat roller 41 and the press roller 42 and the temperature of the heat roller 41.

The printer CPU 170 controls the image forming sections 20C, 20M, 20Y and 20K. The control on the image forming sections 20C, 20M, 20Y and 20K includes control on the electrostatic charger, the developing device, the transfer device and the like. The printer CPU 170 selects an image forming section which is supposed to operate from the image forming sections 20C, 20M, 20Y and 22K according to the image forming mode designated from the operation panel 13, and determines whether or not to operate the selected image forming section, and operates the selected image forming section if it is determined to do so.

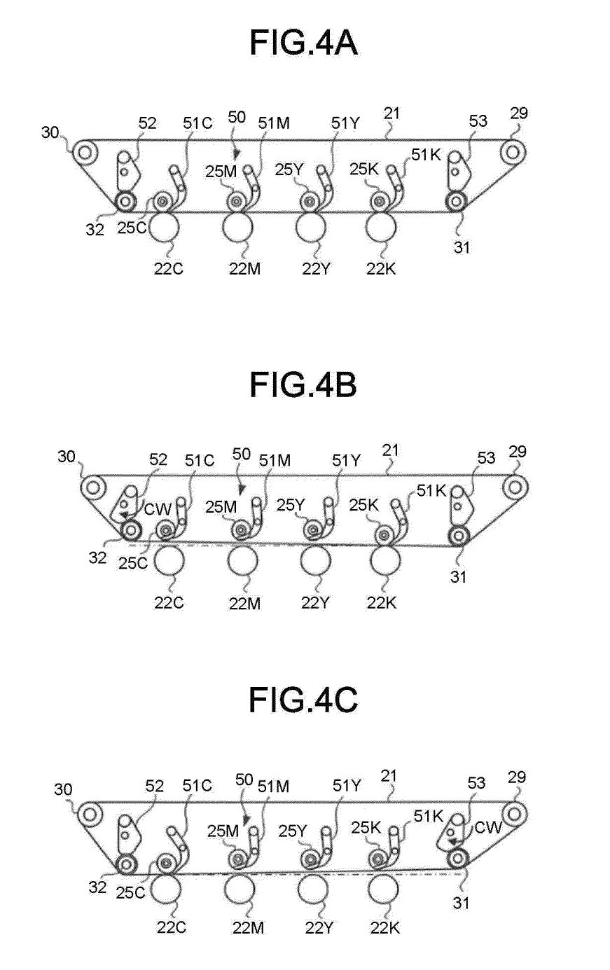

FIG. 4A˜FIG. 4C are diagrams illustrating a moving mechanism 50. For example, in a case of printing monochrome character information and the like, instead of forming a color image, only the BK toner is used to carry out developing processing, which can reduce the consumption amount of toner. In this case, the life of the image forming sections 20C, 20M, 20Y and 20K depends on the operation time, thus, it is preferred not to operate any of the image forming sections except the image forming section 20K.

In a case of forming a monochrome image instead of a color image, if the transfer belt 21 is rotated in a state of contacting with the photoconductive drums 22C, 22M and 22Y, the photoconductive drums 22C, 22M and 22Y and the transfer belt 21 may wear out and be damaged. Thus, the moving mechanism 50 is needed to separate the transfer belt 21 from the photoconductive drums 22C, 22M and 22Y.

As shown in FIG. 4A, the moving mechanism 50 includes lifters 51C, 51M, 51Y and 51K, and roller cams 52 and 53 which are contacted with the driven rollers 31 and 32 respectively. The lifters 51C, 51M, 51Y and 51K can lift the transfer rollers 25C, 25M, 25Y and 25K through hooks of the front ends. The driven rollers 31 and 32 are energized so that they are always contacted with the roller cams 52 and 53. If the roller cams 52 and 53 are rotated in a direction indicated by an arrow CW (clockwise), the driven rollers 31 and 32 move to an upper position, thereby separating the transfer belt 21 from the photoconductive drums 22C, 22M, 22Y and 22K.

The mode can be switched among the full color mode, the monochrome mode using the black color only and the reuse mode using the cyan color only by controlling the operations of the lifters 51C, 51M, 51Y and 51K and the rotation of the roller cams 52 and 53.

FIG. 4A shows a full color mode in which the transfer rollers 25C, 25M, 25Y and 25K are contacted with the photoconductive drums 22C, 22M, 22Y and 22K. In FIG. 4A, the lifters 51C, 51M, 51Y and 51K are not operated and the transfer rollers 25C, 25M, 25Y and 25K are located at a lowered position. The roller cams 52 and 53 are not rotated either, and the transfer belt 21 is contacted with the photoconductive drums 22C, 22M, 22Y and 22K.

FIG. 4B shows a monochrome mode in which the transfer belt 21 is only contacted with the transfer roller 25K and the photoconductive drum 22K and is separated from the transfer rollers 25C, 25M and 25Y for other color and the photoconductive drums 22C, 22M and 22Y. In FIG. 4B, the lifters 51C, 51M and 51Y are rotated to lift the transfer rollers 25C, 25M and 25Y. The roller cam 52 is rotated in the direction indicated by the arrow CW and the driven roller 32 moves upward slightly, thus, the transfer belt 21 is separated from the photoconductive drums 22C, 22M and 22Y. Since the lifter 51K is not operated, only the transfer roller 25K is still at the lowered position, and therefore, the transfer belt 21 is contacted with the transfer roller 25K and the photoconductive drum 22K merely.

FIG. 4C shows a reuse mode in which the transfer belt 21 is contacted with the transfer roller 25C and the photoconductive drum 22C only, and is separated from other transfer rollers 25M, 25Y and 25K and photoconductive drums 22M, 22Y and 22K. In FIG. 4C, the lifters 51M, 51Y and 51K are operated to lift the transfer rollers 25M, 25Y and 25K. The roller cams 53 is rotated in the direction indicated by the arrow CW and the driven roller 31 moves upward slightly, thus, the transfer belt 21 is separated from the photoconductive drums 22M, 22Y and 22K. Since the lifter 51C is not operated, only the transfer roller 25C is still at the lowered position, and therefore, the transfer belt 21 is contacted with the transfer roller 25C and the photoconductive drum 22C merely.

Hereinafter, the operations of each printing mode in the image forming apparatus according to the embodiment are described. The MFP 10 can carry out printing with the color mode, the monochrome mode and the reuse mode. It is possible to select the mode to carry out printing with by operating the operation panel 13. For example, mode selection buttons 61, 62 and 63 are displayed on the display section 15 of the operation panel 13 shown in FIG. 2, and the user can touch any of the buttons 61, 62 and 63 to select a mode. The full color mode is selected by touching the “color” button 61 in FIG. 2. The full color mode uses both inerasable toner and erasable toner to form an image. In a case of full color mode, an image is formed by the image forming sections 20C, 20M, 20Y and 20K. In the full color mode, the moving mechanism 50 is not operated, and as shown in FIG. 4A, the photoconductive drums 22C, 22M, 22Y and 22K and the transfer rollers 25C, 25M, 25Y and 25K are all contacted with the transfer belt 21.

Though erasable cyan toner is used in the developing device 24C of the image forming section 20C, the erasable cyan toner will not be erased if fixed at a general temperature. Thus, there is no difference between the formed image and a color image formed with general inerasable cyan toner.

The monochrome mode is selected by touching the “monochrome” button 62 in FIG. 2. In the monochrome mode, the image forming sections 20C, 20M and 20Y are not operated, and only the image forming section 20K is used to form an image. In the monochrome mode, as shown in FIG. 4B, only the photoconductive drum 22K and the transfer roller 25K are contacted with the transfer belt 21 through the moving mechanism 50. Thus, the image forming sections 20C, 20M and 20Y can be prevented from being driven unnecessarily, and the wear of the photoconductive drums and the transfer belt 21 and the like can be reduced. The monochrome mode is selected in a case of, for example, desiring to store the paper on which important information and the like is printed without reusing the paper.

The reuse mode is selected by touching the “reuse” button 63 in FIG. 2. In the reuse mode, the image forming sections 20M, 20Y and 20K are not operated, and only the image forming section 20C is used to form an image. In the reuse mode, as shown in FIG. 4C, only the photoconductive drum 22C and the transfer roller 25C are contacted with the transfer belt 21 through the moving mechanism 50. Thus, the image forming sections 20M, 20Y and 20K can be prevented from being driven unnecessarily, and the wear of the photoconductive drums and the transfer belt 21 and the like can be reduced. The reuse mode is selected in a case of desiring to recycle the paper.

In addition, in a case of erasing the image printed in the reuse mode, the temperature of the fixing device 40 is set to a temperature higher than the fixing temperature in a general image forming processing, and as a result, the image printed with erasable toner can be erased. The paper can be reused again after the erasing processing.

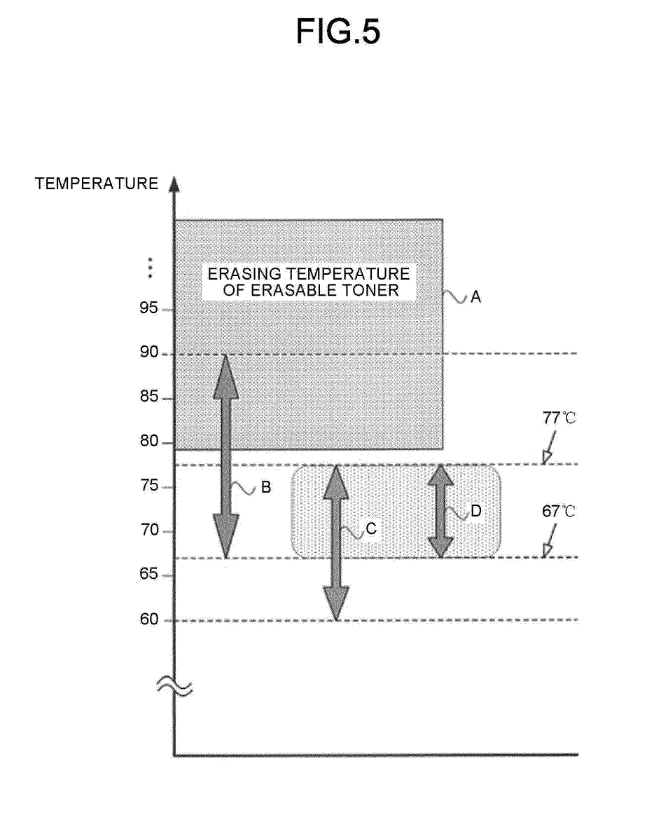

The relation between each toner and the heating temperature of the fixing device 40 is described with reference to FIG. 5. In FIG. 5, A represents a temperature range in which the erasable toner (C toner) can be erased. B represents a temperature range in which the inerasable toner (BK toner, M toner and Y toner) can be fixed. C represents a temperature range in which the erasable toner (C toner) can be fixed. D represents a control range of the fixing temperature in the color mode.

In a case of setting the heating temperature of the fixing device 40:

(1) in the reuse mode, the erasable toner is fixed at a temperature within the temperature range C which is lower than the lower limit temperature of the erasing temperature range A of the erasable toner.

(2) in the monochrome mode and the full color mode, the fixing temperature range D is controlled to be the same or approximately equal.

That is, though the fixing temperature range B of the inerasable toner (BK toner, M toner and Y toner) is, for example, 67˜90 degrees centigrade, in the full color mode, if the temperature of the fixing device 40 is higher than the erasing temperature of the erasable toner (C toner), the cyan is erased when forming a color image, which leads to an image defect. Thus, in the full color mode and the monochrome mode, the temperature of the fixing device 40 is controlled within the temperature range D (for example, 77˜67 degrees centigrade) which is lower than the lower limit value of the erasing temperature of erasable toner to fix each toner. In the reuse mode, the temperature of the fixing device 40 is controlled within the temperature range C (for example, 77˜60 degrees centigrade) which is lower than the lower limit value of the erasing temperature of erasable toner to fix the C toner.

As the heat roller 41 and the press roller 42 of the fixing device 40 is made from a material with high heat storage property such as rubber, a lot of time is taken to lower the temperature after the temperature of the fixing device 40 is raised to carry out heating operation in the image erasing processing. That is, in a case of switching to the monochrome mode or the full color mode after the erasing processing, a lot of time is taken to lower the temperature of the fixing device 40. Thus, the erasing start temperature when erasing the image formed with the erasable toner is not set to be too high. Thus, less time will be taken to lower the temperature of the fixing device 40 in a case of switching to the monochrome mode or the full color mode after the erasing processing,

In the present embodiment, as shown in FIG. 5, the fixing temperature range of the erasable toner (C toner) is set to 60˜77 degrees centigrade, and the fixing temperature range of the inerasable M toner, Y toner and BK toner is set to 67˜77 degrees centigrade. The erasing start temperature of the erasable toner (C toner) is set to 79 degrees centigrade.

It can be known from FIG. 5 that the fixing temperature range D (67˜77 degrees centigrade) of the inerasable toner overlaps with the fixing temperature range C (60˜77 degrees centigrade) of the erasable toner. The fixing control temperature is set within a range from the lower limit value (67 degrees centigrade in FIG. 5) of the fixing temperature range D of the inerasable M toner, Y toner and BK toner to the upper limit value (77 degrees centigrade in FIG. 5) of the fixing temperature range C of the erasable toner.

That is, since the actual temperature change width of the fixing device 40 is 5˜10 degrees centigrade, the fixing device 40 is set so that the range between the lower limit value and the upper limit value is set to be 10 degrees centigrade or more. In the first embodiment, the range between the lower limit value and the upper limit value is set to 10 degrees centigrade, and even in a case of forming an image with both the erasable toner and the inerasable toner, the erasable toner will not be erased at the fixing temperature of the fixing device 40, thus, the occurrence of an image defect and the lower temperature offset (not fixed) state of the inerasable toner can be prevented.

In a case of carrying out printing in the reuse mode immediately after the monochrome printing is carried out with the inerasable toner, there is no need to lower the fixing temperature as long as the temperature is controlled within the temperature range D (a range of 10 degrees centigrade from 67 to 77 degrees centigrade), thus, there is no need to take time to cool the fixing device 40.

### A Second Embodiment

Next, the second embodiment is described. Though the second embodiment is structurally identical to the first embodiment, the characteristic of the toner used in the image forming section is different. That is, in the constitution shown in FIG. 1, the toner used in the image forming sections 20C and 20M is erasable toner, the toner used in the image forming section 20Y is inerasable yellow toner, and the toner used in the image forming section 20K is inerasable black toner.

In the second embodiment, the printing modes which can be selected by the user include “inerasable monochrome mode”, “reuse mode” and “full color mode”. In the “reuse mode”, the color of the erasable image can be selected. That is, in the first embodiment, the erasable toner includes the erasable cyan toner only, while in the second embodiment, the erasable toner includes the erasable cyan toner and erasable magenta toner. Thus, a blue image can be obtained by superimposing the magenta color on the cyan color. In addition, the blue image can be erased, and the variation of erasable color can be increased.

In a case of superimposing the magenta color on the cyan color to form an image, the moving mechanism 50 operates the lifters 51Y and 51K to lift the transfer rollers 25Y and 25K in FIG. 4C. Further, the roller cams 53 is rotated in the direction indicated by the arrow CW and the driven roller 31 moves upward slightly. The transfer belt 21 is separated from the photoconductive drums 22Y and 22K, while as the lifters 51C and 51M are not operated, thus, the transfer belt 21 is contacted with the transfer rollers 25C and 25M and the photoconductive drums 22C and 22M.

Though two colors of toner are set to be erasable toner in the second embodiment, the present invention is not limited to this, and three colors of color toner may be set to be erasable toner. That is, at least one of the three colors of color toner is set to be erasable toner, and an image can be formed with the inerasable black toner.

In accordance with the image forming apparatus according to the embodiments described above, in a case of forming a monochrome image, an image can be formed with the inerasable black toner, and the apparatus is not oversized even if four image forming sections are arranged. It is not necessary to use the cyan (C), magenta (M) and yellow (Y) toner when forming a monochrome image, thus, the cost in the consumed toner will not be raised.

The paper can be reused if the image thereon is formed with the erasable toner. Further, in a case of using, for example, cyan toner as the erasable toner, it is easy to determine whether or not the paper is reusable with eyes by looking at the image formed with cyan color. That is, it can be determined that the paper with black image is not reusable and the paper with cyan image is reusable.

In addition, the present invention is not limited to the embodiments described above, and it may be applied in various forms. For example, though it is exemplified that the printer section 17 is provided with a plurality of control sections such as the conveyance control section 172, the moving mechanism control section 173 and the fixing device control section 174 for controlling the conveyance of the paper S, and controlling the moving mechanism and the fixing device 40, the present invention is not limited to this, and each control may be carried out through a single control section (for example, the main CPU 101 or the printer CPU 170). Further, in addition to the quadruple tandem type image forming section, an image forming apparatus provided with an image forming section including a plurality of developing units is also applicable. An exposure unit provided with a laser light source may be used instead of the scanning heads 19C, 19M, 19Y and 19K including the LED elements.

While certain embodiments have been described, these embodiments have been presented by way of example only, and are not intended to limit the scope of the invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. An image forming apparatus, comprising:
a printer section configured to include a first image forming section which forms a monochrome image with inerasable coloring agent and a plurality of color image forming sections which form at least one color image with erasable coloring agent within a plurality of color images;
a fixing device configured to fix the image formed by the printer section on a recording medium; and
a control section configured to control the printer section so that the printer section operates in a first mode of forming a monochrome image through the first image forming section, a second mode of forming an erasable image with the erasable coloring agent, and a third mode of forming an image through the first image forming section and the plurality of color image forming sections.

2. The image forming apparatus according to claim 1, wherein
at least one color image forming section of the plurality of color image forming sections forms a color image with erasable coloring agent, and the other color image forming sections form color images with inerasable coloring agent.

3. The image forming apparatus according to claim 1, wherein
the plurality of color image forming sections respectively form color images with cyan, magenta and yellow toner at least one of which is erasable toner.

4. The image forming apparatus according to claim 1, wherein
the plurality of color image forming sections respectively form color images with cyan, magenta and yellow toner in which the cyan toner is erasable toner and the magenta and yellow toner is inerasable toner.

5. The image forming apparatus according to claim 1, wherein
the control section sets the temperature of the fixing device within a first temperature range in a case of erasing the erasable image formed on a recording medium, and controls the temperature of the fixing device to a temperature lower than a lower limit value of the first temperature range in a case of fixing the images formed in the first, second and third mode on the recording medium.

6. The image forming apparatus according to claim 5, wherein
the temperature control range of the fixing device in the second mode overlaps with part of the temperature control range of the fixing device in the first and the third mode.

7. The image forming apparatus according to claim 6, wherein
the overlapping temperature control range is 10 degrees centigrade or more.

8. The image forming apparatus according to claim 1, wherein
the printer section does not operate the image forming section which is not used when forming an image in the first mode and the second mode.

9. The image forming apparatus according to claim 1, further comprising:
an operation section through which any of the first, the second and the third modes can be selected; wherein
the control section selects a mode in response to the instruction input from the operation section.

10. An image forming apparatus, comprising:
an image forming apparatus comprising a printer section configured to include a first image forming section which forms a monochrome image with inerasable coloring agent and a plurality of color image forming sections which form at least one color image with erasable coloring agent within a plurality of color images;
a fixing device configured to fix the image formed by the printer section on a recording medium; and
a control section configured to control the printer section so that the printer section operates in a first mode of forming a monochrome image through the first image forming section, a second mode of forming an erasable image with the erasable coloring agent, and a third mode of forming an image through the first image forming section and the plurality of color image forming sections; and control the temperature of the fixing device within a temperature range higher than the temperature of fixing processing so that the erasable image formed on the recording medium is erased by heating by the fixing device.

11. The image forming apparatus according to claim 10, wherein
at least one color image forming section of the plurality of color image forming sections forms an image with the erasable coloring agent, and the other color image forming sections form images with inerasable coloring agent.

12. The image forming apparatus according to claim 10, wherein
the control section sets the temperature of the fixing device within a first temperature range in a case of erasing the erasable image formed on the recording medium, and controls the temperature of the fixing device to a temperature lower than a lower limit value of the first temperature range in a case of fixing the images formed in the first, second and third mode on the recording medium.

13. The image forming apparatus according to claim 12, wherein
the temperature control range of the fixing device in the second mode overlaps with part of the temperature control range of the fixing device in the first and the third mode.

14. The image forming apparatus according to claim 13, wherein
the overlapping temperature control range is 10 degrees centigrade or more.

15. The image forming apparatus according to claim 10, wherein
the printer section does not operate the image forming section which is not used when forming an image in the first mode and the second mode.

16. An image forming method which uses a printer section consisting of a first image forming section for forming a monochrome image with inerasable coloring agent and a plurality of color image forming sections for forming at least one color image with erasable coloring agent within a plurality of color images, including:
controlling the printer section so that the printer section operates in a first mode of forming a monochrome image through the first image forming section, a second mode of forming an erasable image with the erasable coloring agent, and a third mode of forming an image through the first image forming section and the plurality of color image forming sections; and
fixing the images formed in each mode on a recording medium though a fixing device.

17. The image forming method according to claim 16, wherein
at least one color image forming section of the plurality of color image forming sections forms an image with erasable coloring agent, and the other color image forming sections form images with inerasable coloring agent.

18. The image forming method according to claim 16, further comprising:
setting the temperature of the fixing device within a first temperature range in a case of erasing the erasable image formed on a recording medium; and
controlling the temperature of the fixing device to a temperature lower than a lower limit value of the first temperature range in a case of fixing the images formed in the first, second and third mode on the recording medium.

19. The image forming method according to claim 18, wherein
the temperature control range of the fixing device in the second mode overlaps with part of the temperature control range of the fixing device in the first and the third mode.

20. The image forming method according to claim 16, wherein
the printer section does not operate the image forming section which is not used when forming an image in the first mode and the second mode.
